(19) United States
(12) Patent Application Publication
(10) Pub. No.: US 2022/0126639 A1
(43) Pub. Date: Apr. 28, 2022

(54) COUPLING ROD

(71) Applicant: ZF Friedrichshafen AG, Friedrichshafen (DE)

(72) Inventor: Marco BRAUN, Espelkamp (DE)

(21) Appl. No.: 17/434,557

(22) PCT Filed: Feb. 6, 2020
(86) PCT No.: PCT/EP2020/052996

§ 371 Date: Aug. 27, 2021

(30) Foreign Application Priority Data
Mar. 4, 2019 (DE) 10 2019 202 900.0

(51) Int. Cl. B60G 7/00

(52) U.S. Cl. CPC B60G 7/001; B60G 7/005; B60G 2204/416; B60G 2206/81012; B60G 2206/11; B60G 2206/7104; B60G 2206/014

(57) ABSTRACT

A coupling rod for the articulated connection of chassis components. The coupling rod has two joint sockets which are connected to one another along a longitudinal axis by a strut structure. The strut structure has two parallel outer struts connected to one another by a plurality of transverse struts. To provide a coupling rod that has a maximum buckling resistance and tensile strength while taking up the least possible fitting space, relative to the longitudinal axis, the transverse struts make an angle of 45°±10°. A central wall is arranged perpendicularly to the outer struts and connects the outer struts to one another.

This application is a National Stage completion of PCT/EP2020/052996 filed Feb. 6, 2020, which claims priority from German patent application serial no. 10 2019 202 900.0 filed Mar. 4, 2019.

### FIELD OF THE INVENTION

The present invention relates to a coupling rod for the articulated connection of chassis components, having two joint sockets which are connected to one another along a longitudinal axis by a strut structure, wherein the strut structure comprises two outer struts directed parallel to one another which are connected by means of a plurality of transverse struts.

### BACKGROUND OF THE INVENTION

Coupling rods of the type mentioned to begin with are known from the prior art. In particular, as articulated connections between a transverse stabilizer and a spring-mounted wheel carrier component, they form pendulum supports which reduce the rolling behavior of vehicles when driving round a curve. As articulated joints of severely loaded chassis components, such coupling rods must be designed to have sufficient resistance to buckling and must be able to withstand a high tensile stress. Along with all that, they must fit into the restricted fitting space in the area of the wheel suspension, so there is a conflict between the demands of space on the one hand, and the need for strength on the other hand. In addition, the mass of a coupling rod should not exceed a certain application-dependent limit value and the coupling rod must be as light as possible.

For example, DE 10 2012 020 628 A1 discloses a coupling rod in the form of a pendulum support which is made as an injection-molded component by the injection-molding process. Along a longitudinal axis there are two joint sockets connected to one another by a strut structure which comprises a plurality of transverse struts. Despite the already existing strut structure, the coupling rod disclosed still does not meet the strict requirements for buckling resistance and tensile strength.

### SUMMARY OF THE INVENTION

Accordingly, the purpose of the present invention is to provide a coupling rod which, which taking up as little fitting space as possible, has a maximum of buckling resistance and tensile strength.

This objective is achieved by the coupling rod according to the independent claim(s). According to the invention, it is provided that relative to the longitudinal axis the transverse struts make an angle of 45°±10°, and the outer struts are connected to one another by a central wall which is perpendicular to them. The geometry of the strut structure according to the invention surprisingly provides a maximum of buckling resistance and tensile strength while taking up the least possible fitting space. In particular, the through-going central wall results in greater rigidity of the strut structure. Because of that, the respective wall thicknesses of individual struts can if necessary be reduced, which also gives a weight advantage compared with known coupling rods.

Preferred embodiments of the present invention are indicated below and in the subordinate claims.

In a first advantageous embodiment of the invention, it is provided that between the outer struts, at least in some areas, there is arranged a central strut parallel to them, which is connected to the angled transverse struts in such manner that between the central strut, the outer struts, the transverse struts and the central wall, pockets open on one side are formed, preferably of substantially trapezium shape. In particular, the additionally arranged central strut results in even greater rigidity of the coupling rod, with a positive effect on the buckling resistance and the tensile strength. Preferably, by virtue of the trapezium-shaped pockets the flow of a plastic for making the coupling rod is improved. Preferably, thanks to the trapezium-shaped pockets the cores for an injection-molding die for producing the coupling rod are larger. In particular, by virtue of the trapezium-shaped pockets the cores are larger than with triangular pockets. With triangular or triangle-shaped pockets the cores for an injection-molding die are relatively small, so that in particular due to high temperatures and/or pressures in the injection-molding die they wear prematurely or can even break. That risk is considerably reduced by the trapezium-shaped pockets.

In a further development, trapezium-shaped pockets in the area between a first of the two outer struts and the central strut are orientated oppositely to trapezium-shaped pockets between a second of the two outer struts and the central strut. In that way, relative to the central strut trapezium-shaped pockets opposite one another can each have similar sides of the trapezium-shaped pockets facing one another. Preferably the trapezium-shaped pockets are formed symmetrically and/or mirror-symmetrically relative to the central strut. Accordingly, the trapezium-shaped pockets in the area between the first of the two outer struts and the central strut are mirror-symmetrical to the trapezium-shaped pockets in the area between the second of the two outer struts and the central strut. In that way, in each case two of the transverse struts directed from the outer struts toward the central strut meet at the central strut. This benefits the strength of the coupling rod. Of particular advantage for the strength and/or the flow behavior of the plastic is the fact that struts perpendicular to the loading direction and/or the flow direction can be or are completely eliminated.

According to a further preferred design of the invention, it is provided that one joint socket of the coupling rod is in the form of a ball joint socket and the other joint socket is designed to hold a rubber mounting. Such a design of the joint sockets has been found to be particularly advantageous when the coupling rod is used as a pendulum support and thus as a connection between a transverse stabilizer and a spring-mounted wheel carrier.

Preferably, in the area of at least one of the joint sockets the outer struts merge into outer stiffening struts which completely surround the joint socket or both joint sockets. Inasmuch as a central strut is arranged, it is preferably provided that in the area of the socket for the rubber mounting the central strut merges into an inner stiffening strut which completely surrounds the socket for the rubber mounting and is connected by transverse struts to the outer stiffening struts. By extending the outer struts and/or the central strut into stiffening struts, loops are formed around the joint sockets and thereby substantially increase the tensile strength of the coupling rod and therefore its useful life.

To improve the strength of a coupling rod still further, according to a preferred embodiment of the invention it is provided that the ball joint socket forms a dome-shaped section which projects above the surface of an outer strut, wherein the dome-shaped section and the outer strut are preferably connected to one another by a double-walled supporting structure with transverse ribs.

The joint axes of the joint sockets are adapted for the intended installation in the chassis. In particular, they can be directed parallel to each other, or rotated by 90° relative to one another.

The particular strength of the coupling rod according to the invention is attributable not only to the special geometry, but also to the production method. According to a preferred design of the invention, the coupling rod is made by the injection-molding process and is in the form of an injection-molded plastic component. In such an injection-molding process heated and therefore fluid plastic is injected under pressure into an injection-molding die, so that the plastic flows throughout the entire injection-molding die. In the area of the strut structure, between the joint sockets of the coupling rod, there is very homogeneous flow behavior because the struts either extend in the flow direction (outer struts, central strut and central wall) or, so far as the transverse struts are concerned, they are inclined by 45°±10° relative to it. Furthermore, in the area of the strut structure between the joint sockets the coupling rod is free from struts orientated perpendicularly to the flow direction, and this results in harmonious flow behavior and better strength of the coupling rod, in particular along the principal load axis.

To favor uniform flow behavior particularly in the area of the struts between the joint sockets, according to a preferred embodiment of the invention it is provided that the injection-molding process is carried out using an injection-molding die which in the area of the ball joint socket holds a ball joint pin, which pin, during the injection-molding process, is directly or indirectly overmolded with plastic in such manner that in the hardened condition the coupling rod is connected to the ball joint pin in a form-enclosing manner. For that purpose an injection point, in particular the injection point during injection-molding, is preferably arranged on the ball joint socket, in particular on the dome-shaped section of the ball joint socket. In this way too the fluid plastic flows through the strut structure between the joint sockets in a uniform direction, which once the plastic has hardened results in better strength of the coupling rod. In the case of indirect overmolding of the ball joint pin, the plastic material is injected directly around the ball joint pin so that in the hardened condition the ball joint pin is in contact with the plastic material of the coupling rod. For indirect overmolding a ball shell is provided, which surrounds the ball joint pin already during the injection-molding process and forms the surface of the joint. Such a ball shell is preferably made from polyoxymethylene (POM).

### BRIEF DESCRIPTION OF THE DRAWINGS

Specific embodiments of the present invention are explained below with reference to the figures, which show:

FIG. 1a: A perspective view of a coupling rod,

FIG. 1b: A cross-sectional view along section line 1b-1b of FIG. 1a of the coupling rod,

FIG. 1c: A cross-sectional view along section line 1c-1c of FIG. 1b of the coupling rod, and

FIG. 2: A perspective view of a further coupling rod.

### DETAILED DESCRIPTION OF THE PREFERRED EMBODIMENTS

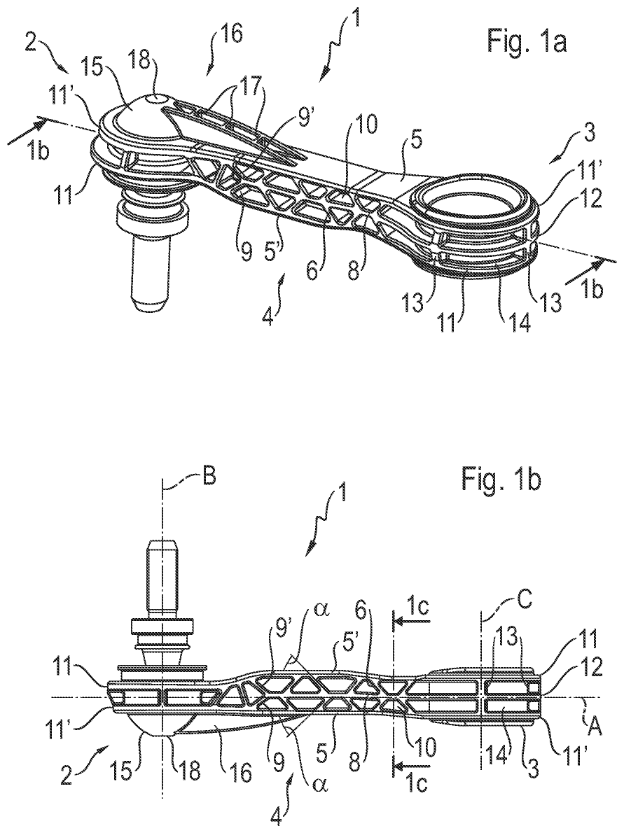

FIG. 1a shows a perspective view of a first example embodiment of a coupling rod 1 according to the invention for the articulated connection of chassis components (not shown), with two joint sockets 2, 3. The joint sockets 2, 3 are connected to one another along a longitudinal axis A by means of a strut structure 4, which comprises two parallel outer struts 5, 5′. The outer struts 5, 5′ are connected at least indirectly to one another by a plurality of transverse struts 6, which relative to the longitudinal axis A make an angle α of 45° (see FIG. 1b). The outer struts 5, 5′ are also connected by a perpendicular central wall 7, which is shown in the cross-sectional illustration of FIG. 1c. Furthermore, between the outer struts 5, 5′ and along the longitudinal axis A, a central strut 8 is formed. In the example embodiment shown, the central strut 8 is not through-going from the joint socket 2 to the joint socket 3, but rather, it extends starting from the joint socket 3 approximately into the second half (shown on the left) of the strut structure 4, where the central strut 8 merges via two transverse struts 9, 9′ into the outer struts 5, 5′. The central strut 8 is connected to the transverse struts 6, 9, 9′ arranged at an angle, in such manner that between the central strut 9, the outer struts 5, 5′, the transverse struts 6, 9, 9′ and the central wall 7 essentially trapezium-shaped pockets 10 open on one side are formed.

The joint sockets 2, 3 can be designed in various ways. In the embodiment shown, the joint socket 2 is a ball joint socket and the joint socket 3 is designed to hold a rubber mounting. Both of the joint sockets 2, 3 are completely surrounded by stiffening struts 11, 11′ which in the area of the strut structure 4 merge into the outer struts 5, 5′. In the area of the socket for the rubber mounting and therefore in the area of the joint socket 3, the central strut 8 shown in FIG. 1a also merges into an inner stiffening strut 12 which completely surrounds the socket for the rubber mounting and is connected by transverse struts 13 to the outer stiffening struts 11, 11′. The transverse struts 13 are directed essentially parallel to one another, so that between the transverse struts 13, the outer stiffening struts 11, 11′ and the central stiffening strut 12, pockets 14 with rectangular cross-sections are formed.

The joint socket 2 in the form of a ball joint socket has a dome-shaped section 15 which projects above the surface of the outer strut 5. To stiffen the coupling rod 1 further, the dome-shaped section 15 and the outer strut 5 are connected by a double-walled supporting structure 16 with parallel transverse ribs 17.

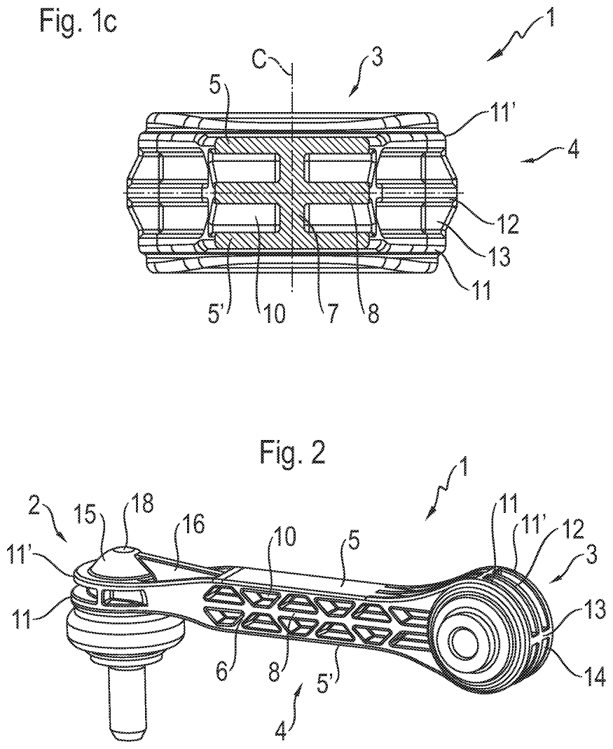

In the example embodiment shown, the joint axes B, C are directed parallel to one another. In contrast, FIG. 2 shows an embodiment of a coupling rod 1 in which the joint axes B. C are rotated through 90° relative to one another. In other respects the design according to FIG. 2 corresponds essentially to the design shown in FIGS. 1a-c, although owing to the rotation the stiffening struts 11, 11′ and 12 do not merge with the outer struts 5, 5′ or the central strut 8. Moreover. in the embodiment according to FIG. 2 the central strut 8 is through-going and connects the joint sockets 2, 3. In this example embodiment the outer struts 5, 5′ are parallel to one another and symmetrical relative to the central strut 8. In addition, the trapezium-shaped pockets 10 are formed and arranged mirror-symmetrically relative to the central strut 8.

The coupling rods 1 in the embodiments shown are produced by the injection-molding process. For this, in the area of the ball joint socket and thus the joint socket 2, in particular there in the area of the dome-shaped section 15, a flattened area 18 is provided, which forms the point of injection. During the production of a coupling rod 1, at that point the fluid plastic is injected into an injection-molding die, and flows from there out through the whole of the injection-molding die. When the injection-molding process is carried out the injection-molding die already holds a ball joint pin in the area of the ball joint socket, which pin is directly overmolded with plastic during the injection-molding. In the hardened condition of the coupling rod 1, the ball joint pin is already surrounded in a form-enclosing manner and does not have to be pressed into the joint socket by expanding the latter.

### INDEXES

### 1 Coupling rod

2 Joint socket
3 Joint socket
4 Strut structure
5, 5′ Outer struts
6 Transverse struts
7 Central wall
8 Central strut
9, 9′ Transverse struts

### 10 Pocket

11, 11′ Stiffening struts
12 Stiffening strut
13 Transverse strut

### 14 Pocket

15 Dome-shaped section
16 Double-walled supporting structure

### 17 Transverse rib

18 Flattened area
A Longitudinal axis
B, C Joint axes

### α Angle

1-10. (canceled)

11. A coupling rod for the articulated connection of chassis components, the coupling rod comprising:
two joint sockets (2, 3) which are connected to one another, along a longitudinal axis (A), by a strut structure (4),
the strut structure (4) comprising two outer struts (5, 5′) directed parallel to one another, which are connected to one another by a plurality of transverse struts (6, 9, 9′),
the transverse struts (6, 9, 9′) are angled at 45°±10° relative to the longitudinal axis (A), and
a central wall (7) of the coupling rod is arranged perpendicular to the two outer struts (5, 5′) and connects the two outer struts (5. 5′) to one another.

12. The coupling rod according to claim 11, wherein between the two outer struts a parallel central strut (8) is arranged, at least is some areas, which is connected to the angled transverse struts (6) in such a manner that essentially trapezium-shaped pockets (10), open on one side, are formed between the central strut (8), the two outer struts (5, 5′), the transverse struts (6) and the central wall (7).

13. The coupling rod according to claim 12, wherein the trapezium-shaped pockets (10), in an area between a first one of the two outer struts (5) and the central strut (8), are orientated oppositely to the trapezium-shaped pockets (10) in an area between a second one of the two outer struts (5′) and the central strut (8), and the trapezium-shaped pockets (10) are formed mirror-symmetrically relative to the central strut (8).

14. The coupling rod according to claim 11, wherein one joint socket (2) is in a form of a ball joint socket and the other joint socket (3) is designed to hold a rubber mounting.

15. The coupling rod according to claim 11, wherein in an area of at least one of the joint sockets, the two outer struts (5, 5′) merge into outer stiffening struts (11, 11′), which completely surround at least one of the joint sockets (2, 3).

16. The coupling rod according to claim 12, wherein in an area of a socket for a rubber mounting, the central strut (8) merges into an inner stiffening strut (12) which completely surrounds the socket for the rubber mounting and which is connected to the outer stiffening struts (11, 11′) by transverse struts (13).

17. The coupling rod according to claim 14, wherein the ball joint socket comprises a dome-shaped section (15) which projects above a surface of an outer strut (5), and the dome-shaped section (15) and the outer strut (5) are joined to one another by a double-walled supporting structure with transverse ribs (17).

18. The coupling rod according to claim 11, wherein each of the two joint sockets defines a joint axis, and the joint axes (B, C) are mutually parallel or are arranged 90° relative to one another.

19. The coupling rod according to claim 11, wherein the coupling rod (1) is made by the injection-molding process and is in a form of an injection-molded plastic component, and the injection-molding process is carried out using an injection-molding die which, in an area of a ball joint socket, holds a ball joint pin, which pin, during the injection-molding process, is directly or indirectly overmolded with plastic in such manner that in a hardened condition the coupling rod (1) is connected to the ball joint pin in a form-enclosing manner.

20. The coupling rod according to claim 19, wherein an injection point for injection-molding is arranged on the ball joint socket on the dome-shaped section (15) of the ball joint socket.

21. A coupling rod for the articulated connection of chassis components, the coupling rod comprising:
two joint sockets (2, 3) being connected to one another along a longitudinal axis (A) by a strut structure (4),
the strut structure (4) comprising two outer struts (5, 5′) arranged parallel to one another, the two outer struts being connected to one another by a plurality of transverse struts (6, 9, 9′), and the transverse struts (6, 9, 9′) being arranged, relative to the longitudinal axis (A), at an angle of 45°±10°, and
a central wall (7) of the coupling rod being arranged perpendicular to the two outer struts (5, 5′) and connecting the two outer struts (5. 5′) to one another.
